(19) United States
(12) Patent Application Publication
(10) Pub. No.: US 2013/0333512 A1
(43) Pub. Date: Dec. 19, 2013

(54) Steering Wheel Cover

(71) Applicants: Yu HE, Ningbo (CN); Jiangqiang YOU, Ningbo (CN)

(72) Inventors: Yu HE, Ningbo (CN); Jiangqiang YOU, Ningbo (CN)

(21) Appl. No.: 13/623,211

(22) Filed: Sep. 20, 2012

(30) Foreign Application Priority Data
Jun. 15, 2012 (CN) 201220296126.4

(51) Int. Cl. B62D 1/06

(52) U.S. Cl. 74/558

(57) ABSTRACT

The present disclosure relates to automobile parts, particularly to a cover for a steering wheel, the cover comprising a main collar and an inner collar, wherein the inner collar is made of ethylene-vinyl acetate material and is attached to an inner side of the main collar.

The steering wheel cover of the present disclosure provides several advantages: The inner collar of the cover is light, anti-slip, non-toxic, and odorless; it features good elasticity and low cost; and it is environmental friendly. Further, one or more anti-slip sheets which may be provided on the main collar can make the steering wheel cover better anti-slip and safer. One or more air holes may be further provided which can make drivers more comfortable.

### TECHNICAL FIELD

The present disclosure relates to automobile parts, particularly to a cover for a steering wheel.

### BACKGROUND

On the present market a majority of inner collars for steering wheel covers are made of rubber or plastics. People are more and more concerned about environmental protection and have found that inner collars made of rubber either emit strong smell or are expensive; also, the price of plastics is usually high. Hence, it is desired to find cost-effective and environmental friendly materials to replace rubber and plastics.

### SUMMARY

The present disclosure provides a steering wheel cover with an inner collar which is light, anti-slip, non-toxic, and odorless, and which features good elasticity and low cost. The steering wheel cover comprises a main collar and an inner collar, wherein the inner collar is made of ethylene-vinyl acetate material and is attached to the main collar.

As further improvement, the inner collar may be stitched to the main collar.

As further improvement, the material of the inner collar is ethylene-vinyl acetate; one or more anti-slip spots may be provided on the inner collar.

As further improvement, a diameter of the inner collar is 300 mm-700 mm.

As further improvement, a length of an arc of a cross section of the inner collar is 60 mm-110 mm.

As a further improvement, one or more anti-slip sheets may be provided on an outer side of the main collar. The one or more anti-slip sheets may be stitched to the main collar.

As further improvement, one or more holes may be provided on at least one of the one or more of said anti-slip sheets.

The steering wheel cover of the present disclosure provides several advantages: The inner collar of the cover is light, anti-slip, non-toxic, and odorless; it features good elasticity and low cost; and it is environmental friendly. Further, one or more anti-slip sheets which may be provided on the main collar can make the steering wheel cover better anti-slip and safer. One or more air holes may be further provided which can make drivers more comfortable.

### BRIEF DESCRIPTION OF THE DRAWINGS

FIG. 1 is a diagram showing a steering wheel cover of the present disclosure.

### DETAILED DESCRIPTION OF PREFERRED EMBODIMENTS

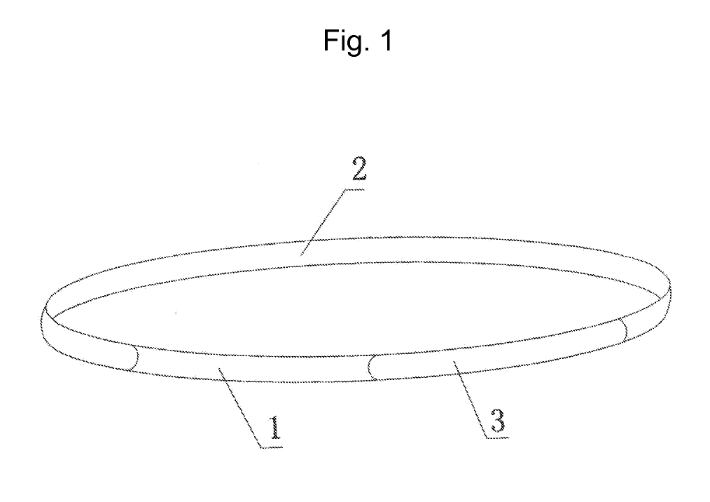

As shown in FIG. 1, a steering wheel cover comprises a main collar (1) and an inner collar (2) which is made of ethylene-vinyl acetate material and attached to the main collar (1). The inner collar (2) may be stitched to the main collar (1) with thread along edges of the inner collar (2). (The inner collar (2) may also be glued to the main collar (1).) One or more anti-slip spots are provided on an inner side of the inner collar (2). A diameter of the inner collar is 300 mm-700 mm. A length of an arc of a cross section of the inner collar is 60 mm-110 mm.

One or more, e.g. three, anti-slip sheets (3) are provided on an outer side of the main collar (1). The anti-slip sheets (3) may be stitched to the main collar (1). One or more holes are provided on at least one of the anti-slip sheets (3).

1. A steering wheel cover comprising a main collar and an inner collar, wherein said inner collar is made of ethylene-vinyl acetate material and is attached to an inner side of said main collar.

2. The steering wheel cover of claim 1, wherein said inner collar is stitched to said main collar.

3. The steering wheel cover according to claim 1, wherein one or more anti-slip spots are provided on said inner collar.

4. The steering wheel cover according to claim 1, wherein a diameter of said inner collar is 300 mm-700 mm.

5. The steering wheel cover according to claim 1, wherein a length of an arc of a cross section of said inner collar is 60 mm-110 mm.

6. The steering wheel cover according to claim 1, wherein one or more anti-slip sheets are provided on an outer side of said main collar.

7. The steering wheel cover according to claim 6, wherein said one or more anti-slip sheets are stitched to said main collar.

8. The steering wheel cover according to claim 6, wherein one or more holes are provided on at least one of the one or more of said anti-slip sheets.
